(19) United States
(12) Patent Application Publication
(10) Pub. No.: US 2026/0330025 A1
(43) Pub. Date: Oct. 22, 2026

(54) ASSESSING POST-QUANTUM READINESS OF ASSETS AND PRODUCTS

(71) Applicant: Cisco Technology, Inc., San Jose, CA (US)

(72) Inventors: Ashish Kundu, Milpitas, CA (US); Ramana Rao V.R. Kompella, Foster City, CA (US)

(73) Assignee: Cisco Technology, Inc., San Jose, CA (US)

(21) Appl. No.: 19/319,119

(22) Filed: Sep. 4, 2025

Related U.S. Application Data
(60) Provisional application No. 63/791,814, filed on Apr. 21, 2025.

(51) Int. Cl. G06F 21/57

(52) U.S. Cl. CPC G06F 21/577

(57) ABSTRACT

In one implementation, a device obtains documentation regarding components of a computing product located at one or more uniform resource locators. The device forms a prompt for input to one or more large language models based on the documentation. The device calls, using the prompt, the one or more large language models to make an assessment as to whether the components of the computing product are cryptographically resistant to quantum computers. The device provides an indication of the assessment to a user interface.

### RELATED APPLICATION

This application claims priority to U.S. Provisional Application No. 63/791,814, filed Apr. 21, 2025, entitled “ASSESSING POST-QUANTUM READINESS OF ASSETS AND PRODUCTS” by Kundu, et al., the contents of which are incorporated herein by reference.

### TECHNICAL FIELD

The present disclosure relates generally to communications and, more particularly, to assessing the post-quantum readiness of assets and products.

### BACKGROUND

Many of the cryptographic protocols in use today were not designed with quantum computing in mind, presenting new challenges for network security. Generally, quantum computing represents a significant shift in technology. Traditionally, computers have relied on bits that represent the binary states of their constituent transistors (i.e., a ‘1’ or a ‘0’). In contrast, quantum computers rely on quantum bits, which are referred to as “qubits,” which are two-state, quantum mechanical systems that can represent not only the traditional binary values of ‘1’ and ‘0,’ but also the superposition of the two, as well.

For instance, a quantum computer executing Shor's algorithm with enough qubits could be used to break commonly used public key cryptography protocols, such as Rivest-Shamir-Adelman (RSA), certain variations of Diffie-Hellman key exchange (e.g., elliptic curve, finite field, etc.), and the like. This creates a moving target for security experts, as the encryption protocols that network devices use to encrypt their traffic become increasingly vulnerable to advances in quantum computing.

Computing systems are complex and often include many components that are sourced from different vendors. This complexity makes it difficult to assess the security of the system in a post-quantum world. Indeed, different components may use different cryptographic protocols that have varying resistance, or even no resistance, to post-quantum computing.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example computing device/node;

FIG. 3 illustrates an example of a user interfacing with a generative model;

FIG. 4 illustrates an example architecture for an artificial intelligence (AI) agent;

FIG. 5 illustrates an example architecture for assessing the post-quantum readiness of an asset or product;

FIG. 6 illustrates an example of the assessment of different products for their post-quantum readiness based on their product information;

FIGS. 7A-7F illustrate example screenshots of a prototype post-quantum readiness advisor;

FIG. 8 illustrates an example cryptography vulnerability graph; and

FIG. 9 illustrates an example simplified procedure for assessing the post-quantum readiness of assets and products, in accordance with one or more implementations described herein.

### DESCRIPTION OF EXAMPLE IMPLEMENTATIONS

### Overview

According to one or more implementations of the disclosure, a device obtains documentation regarding components of a computing product located at one or more uniform resource locators. The device forms a prompt for input to one or more large language models based on the documentation. The device calls, using the prompt, the one or more large language models to make an assessment as to whether the components of the computing product are cryptographically resistant to quantum computers. The device provides an indication of the assessment to a user interface.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P 1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

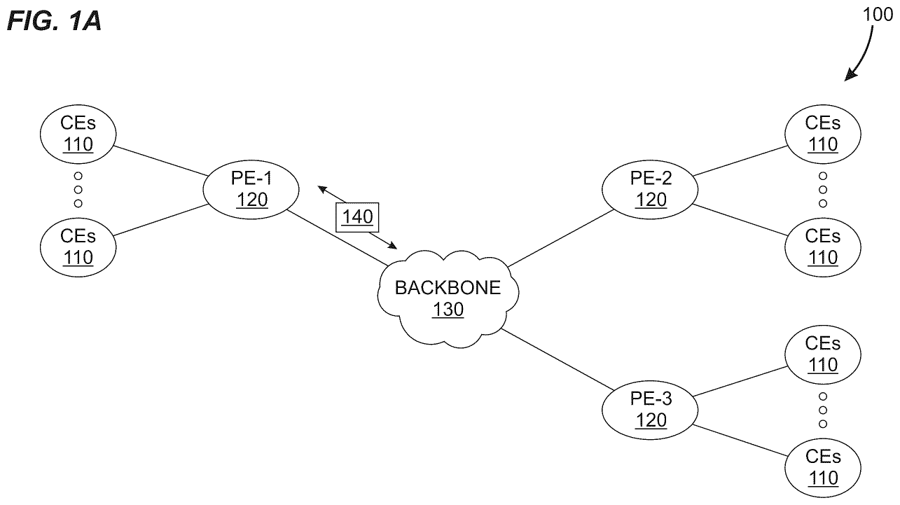

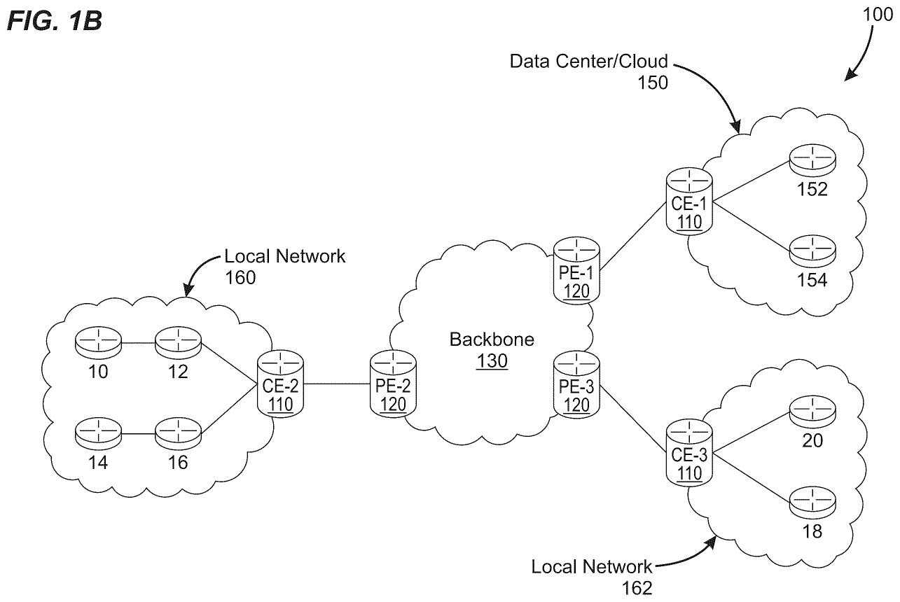

FIG. 1A is a schematic block diagram of an example network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as network backbone 130. For example, CE routers 110, 120 may be interconnected by the public Internet, a multiprotocol label switching (MPLS) virtual private network (VPN), or the like. Data packets 140 (e.g., traffic/messages) may be exchanged among the nodes/devices of the network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular one of CE routers 110 shown in network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B 2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first one of CE routers 110 connected to PE-2 and a second one of CE routers 110 connected to PE-3.

FIG. 1B illustrates an example of network 100 in greater detail, according to various implementations. As shown, network backbone 130 may provide connectivity between devices located in different geographical areas and/or different types of local networks. For example, network 100 may comprise local networks 160-162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

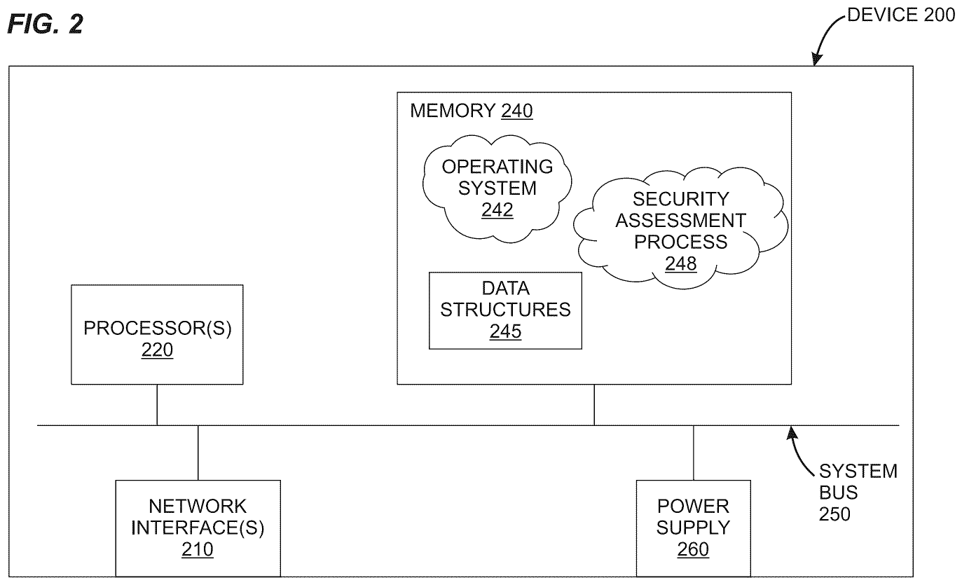

FIG. 2 is a schematic block diagram of an example node/device 200 (e.g., an apparatus) that may be used with one or more implementations described herein, e.g., as any of the devices shown in FIGS. 1A-1B above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s), such as network 100. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a security assessment process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, security assessment process 248 may include computer executable instructions that, when executed by processor 220, cause device 200 to perform the techniques described herein. To do so, in some implementations, security assessment process 248 may utilize artificial intelligence (AI)/machine learning (ML). In general, AI/ML is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, security assessment process 248 may leverage one or more supervised, unsupervised, or semi-supervised AI/ML models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/ML techniques that the security assessment process 248 may employ include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, security assessment process 248 may also include, or otherwise use, one or more generative AI/ML models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, security assessment process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

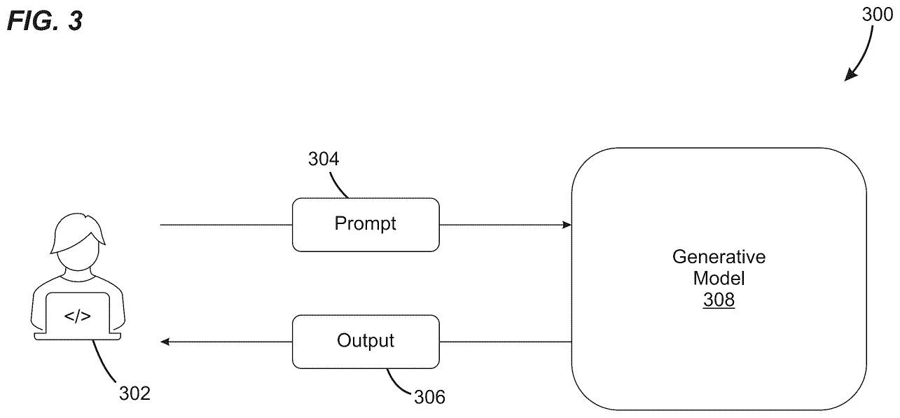

FIG. 3 illustrates an example 300 for interfacing with a generative model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated/synthesized image, a text response, a classification, a prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

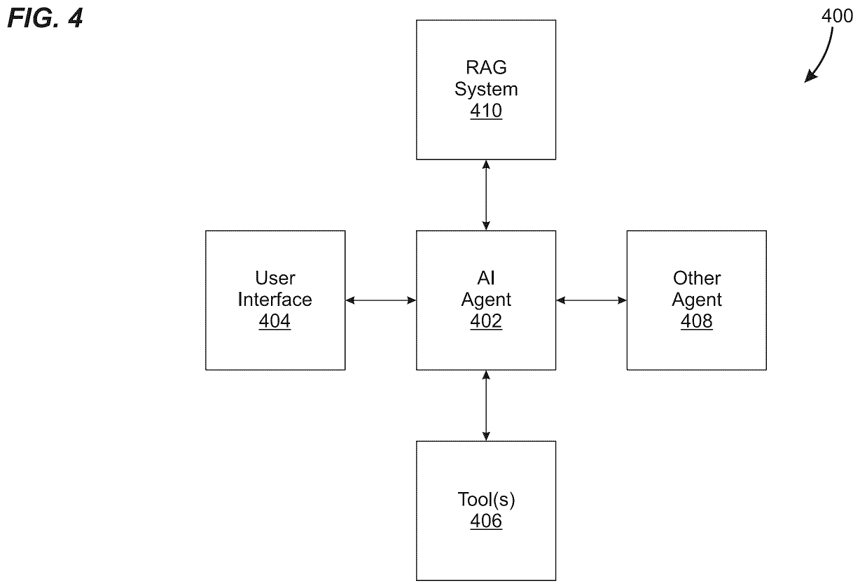

FIG. 4 illustrates an example architecture 400 for an artificial intelligence (AI) agent, according to various implementations. At the core of architecture 400 is AI agent 402. As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, many of the cryptographic protocols in use today were not designed with quantum computing in mind, presenting new challenges for network security. Generally, quantum computing represents a significant shift in technology. Traditionally, computers have relied on bits that represent the binary states of their constituent transistors (i.e., a ‘1’ or a ‘0’). In contrast, quantum computers rely on quantum bits, which are referred to as “qubits,” which are two-state, quantum mechanical systems that can represent not only the traditional binary values of ‘1’ and ‘0,’ but also the superposition of the two, as well.

For instance, a quantum computer executing Shor's algorithm with enough qubits could be used to break commonly used public key cryptography protocols, such as Rivest-Shamir-Adelman (RSA), certain variations of Diffie-Hellman key exchange (e.g., elliptic curve, finite field, etc.), and the like. This creates a moving target for security experts, as the encryption protocols that network devices use to encrypt their traffic become increasingly vulnerable to advances in quantum computing.

Computing systems are complex and often include many components that are sourced from different vendors. This complexity makes it difficult to assess the security of the system in a post-quantum world. Indeed, different components may use different cryptographic protocols that have varying resistance, or even no resistance, to post-quantum computing.

### Assessing Post-Quantum Readiness of Assets and Products

The techniques herein introduce an automated system for assessing the quantum readiness of assets and products. As would be appreciated, such assets and products may take the form of computing devices, systems, and/or network services.

Illustratively, the techniques described herein may be performed by hardware, software, and/or firmware, such as in accordance with security assessment process 248, which may include computer executable instructions executed by the processor 220 (or independent processor of interfaces 210) to perform functions relating to the techniques described herein.

Specifically, according to various implementations, a device obtains documentation regarding components of a computing product located at one or more uniform resource locators. The device forms a prompt for input to one or more large language models based on the documentation. The device calls, using the prompt, the one or more large language models to make an assessment as to whether the components of the computing product are cryptographically resistant to quantum computers. The device provides an indication of the assessment to a user interface.

Operationally, the techniques herein introduce a post-quantum cryptography (PQC) advisor (e.g., through execution of security assessment process 248) that analyzes the description of products and/or their datasheets for the various components of a computing system, to determine the cryptographic protocols that they use. In some implementations, the PQC advisor uses an LLM to make an assessment of the post-quantum risks to the computing system. As would be appreciated, the terms “product” and “asset” are used herein largely synonymously to refer to any device, software, combination thereof, and/or set thereof, in a computing system.

More specifically, in various implementations, the PQC advisor may:
Use LLMs. We are in the process of making it Agent-based and RAG-based.
Take the Uniform Resource Locator (URL) of the description of the products, extracts the datasheets and other information
Find the ciphersuites for each asset and the way they are used, configured.
Output JSON, which is also then stored as a spreadsheet.
Support human review and editing
Once approved, it is ready to published or shared.
It can generate a ciphersuite dependency graph for one product/asset or across multiple assets configured/used together.
The PQC advisor may also generate Cryptography Bill of Materials (CBOM) based on this assessment.
It supports consistency analysis of the outputs to ensure the inconsistencies generated are addressed by human review or by other means.

In other words, the PQC advisor may determine whether a given asset, system, product, network code, or the like, is using a post-quantum/quantum-ready cryptographic protocol. Further aspects relate to the PQC indicating the readiness posture of that entity and/or generating its CBOM.

In some implementations, the PQC advisor may use a generative AI-based approach, such as using an LLM for its assessments. In such a case, the inputs may include any or all of the following:
text descriptions
multi-modal descriptions
URL(s) of description of an asset or product
data sheets
security documentation focusing on cryptography
source code, binary code
logs, observability data
network communication data
supply chain data
system architecture diagrams, graphs representing a system design with cryptography and security subsystems, control and data flow, call graphs
system calls supported by the OS, kernels, etc. (e.g., a list of systems calls that include cryptography-specific calls and/or related calls).
programming languages, their descriptions, and/or documentation
scripting languages including shell scripts and/or their documentation
database query languages (e.g., SQL, etc.)
database queries
other system commands, calls, or queries
firmware documentation
any documentation, record, or information related to cryptography, its use, or policies in one or the other
access control policies
authentication policies
threat information
threat reports
STIX documentation
instruction sets of system architectures such as Intel i7, ARM computing architecture, NVIDIA GPU, cryptography accelerators, and so on (e.g., to determine cryptography usages, or features, whether they are quantum-ready, quantum-safe and how to remediate as well as such input can be used to provide outputs as per the specification)

In one implementation, the PQC advisor may also use one or more AI/ML models to analyze the input data and classify, or otherwise determine, whether more data is required for better accuracy.

The PQC may also use prompts for its LLM in various ways such as any of the following:
if sensitive cryptography and security information about products, use trustworthy single-tenant or secure LLMs on-premise or off-premise
use self-validation or cross-validation across LLMs
if prompts are leading to errors or inconsistencies, or low confidence
use chain of thoughts
with or without RAGs
extract cryptography usage: protocols, ciphersuites, versions, post-quantum-readiness; output as JSON
validate JSON

The PQC advisor may also compute cryptography dependency graphs (CDG), in one implementation. In a further implementation, the PQC advisor may compute the ciphertext supply chain from extracted data and/or the CDG, to generate a cryptography bill of materials (CBOM) for the asset or product. The PQC advisory may also validate its outputs, such as by validating the output JSON, CDG, CBOMs, etc. for accuracy, consistency, and lack of hallucinations across each other and/or across other such output data generated for other products or similar products. In turn, the PQC advisor may also correct, remediate, and finalize these outputs if needed. As a result, the PQC advisory may output any or all of the following: JSON, CDG, CBOMs, graph representation of CDG.

In further implementations, the PQC advisory may be agent-based. In some implementations, the agents may be autonomous and configured to ask for more information or specific URLs for improving the quality of their outputs for quantum-safety analysis of an asset or product as required by the user. For instance, the PQC agent(s) may proceed as follows:
0. Take input.
   0a. provide URLs as an input as in the web page; —go for it now as it is done. In other instances, the contents can also be structed as graphs or other data structures.
   0b. or via the associated REST API. (next week: if you do not have REST APIs for this work-enable/wrap the system with REST APIs).
   0c. Provide SAGA graph/JSON as an input describing the system architecture graph, or infrastructure/network architecture graph (SAGA JSON)—remember SAGA
1. Master agent takes all input provided as input to the web UI
2. It determines how many agents are needed—by determining—how many URLs are there; if one URL contains multiple products, assets or devices; if SAGA JSON is given, does a BFS on the SAGA graph.
3. sends URL(s) per product/asset to each agent;
   3a. Each agent processes their URLs.
   3b. retrieves more info for that product;
   3c. analyzes and extracts cryptographic information; with or without using RAGs or agentic RAGs.
   3d. determines the quantum-readiness of cryptographic information;
   3e. outputs JSON for PQC-readiness posture.
4. validates the output for consistency, incorrectness, hallucination using
   4a. self-validation
   4b. cross-validation-across other LLMs, or other agents
   4c. chain of thoughts, or distributed chain of thoughts across multiple agents
5. apply chain of thoughts to remediate the issues found in 4.
6. ask human input for validation and correction or more input data, or guidance if 4 and 5 result in higher levels of issues; low confidence: it can be interactive or non-interactive.
7. finalize the JSON
8. generate cryptography vulnerability graph (CVG) that has vertices representing ‘x’: ciphersuites/cryptography protocols/cryptography libraries/configurations, vertices representing ‘y’: vulnerabilities/weaknesses of vertices for ‘x’, vertices representing ‘z’: sources of threats such as Shor's or Grover's algorithms or other threats to the vertices ‘x’ resulting in the vulnerabilities/weaknesses represented by ‘y’, and edges represent relationships between these vertices of types ‘x’, ‘y’ and ‘z’; it also generates generates cryptography dependency graph (CDG), where dependencies represented by edges between vertices representing ciphersuites, cryptography protocols, cryptography libraries, configurations and other aspects of cryptography, their usage, context, and system components.
9. generate cryptography bill of materials (CBOM)
10. output JSON, CDG, CBOM
11. send output to master agent
12. master agent combines all of the outputs together from all PQC-agents using an algorithm for each JSON, for CDG, for CBOM;
   12a. go to 16 if risk analysis is not enabled.
13. master agent asks risk analysis agents to carry out risk analysis
14. risk analysis agents return risks
15. outputs risks.
16. returns to the web UI or to the REST API asynchronously.

In yet other implementations, the PQC advisor may take the form of a human-assisted, interactive system or a non-interactive system. Here, the system may also incorporate feedback or input from a human user and/or from a non-interactive system.

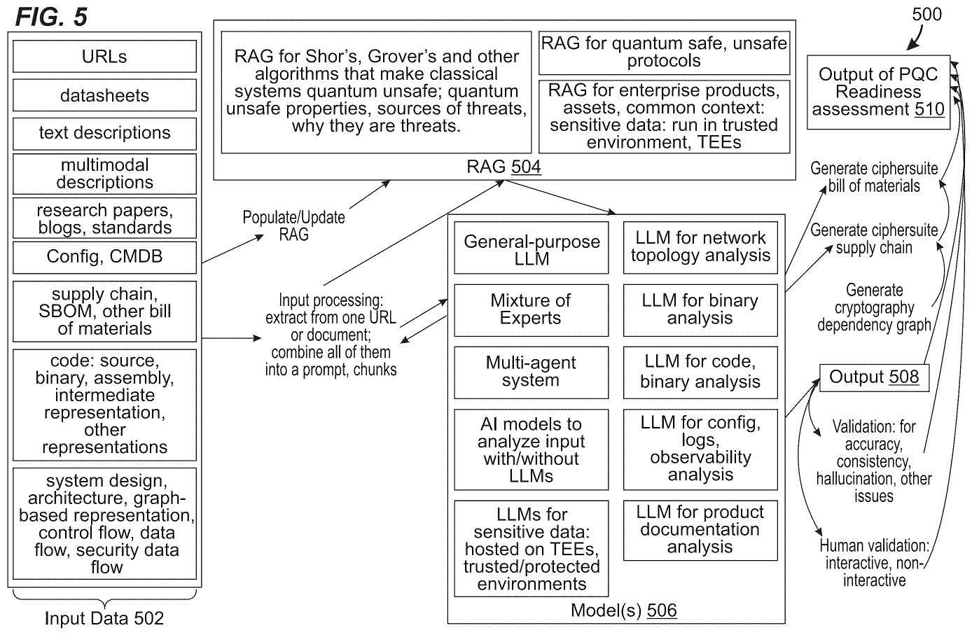

FIG. 5 illustrates an example architecture 500 for the PQC advisor, in some implementations. In various implementations, architecture 500 may be implemented through the execution of security assessment process 248 by a specifically-configured device (e.g., device 200), to function as a PQC advisor.

As shown, the PQC advisor may take as input any or all of the following input data 502:
The URL(s) at which the product documentation or other information is located for the product of interest
Datasheets for the product of interest
Text descriptions for the product of interest
Multimodal descriptions for the product of interest (e.g., video, audio, text, etc.)
Research papers, blogs, or standards that are relevant to the product of interest
Configuration and/or CMDB information for the product of interest
Supply chain, SBOM, and/or other BOM information for the product of interest
Code associated with the product of interest
System design, architecture, etc. information for the product of interest.
Etc.

In various implementations, the PQC advisor may obtain any or all of the above information based on user input (e.g., via a user interface) and/or automatically by interfacing with one or more computer systems. For instance, in one implementation, a user may specify the URLs via a user interface at which the above information may be located. In other implementations, the PQC advisor may perform searching to identify the locations and ingest the above information.

Using input data 502, the PQC advisor may populate RAG 504. As shown, in some implementations, RAG 504 may comprise separate RAGs any or all of the following:
Threats associated with quantum computing-algorithms that a quantum computer could use (e.g., Shor's algorithm, Grover's algorithm, etc.), quantum unsafe properties, sources of threats, descriptions as to why these are threats, etc.
Protocols that are deemed quantum save or unsafe
Product information

Using RAG 504 (e.g., to supplement one or more prompts generated by the PQC advisory), the PQC advisor may leverage model(s) 506 to make its assessments. As shown, model(s) 506 may comprise a general-purpose LLM, a mixture-of-experts (MoE) model, a multi-agent system, AI models to analyze inputs with or without LLMs, LLMs for sensitive data, LLMs for network topology analysis, LLMs for binary analysis, LLMs for code/binary analysis, LLMs for configuration/logs/observability analysis, LLMs for product documentation analysis, combinations thereof, or the like. In further implementations, model(s) 506 may take the form of non-LLM models, other generative AI models and/or agents, or even non-AI approaches (e.g., rule-based processing, etc.).

In turn, model(s) 506 may generate output data 508 which may entail generating a ciphersuite BOM, a ciphersuite supply chain, a cryptology dependency graph. Output data 508 may also include validation information from an automated analysis (e.g., to validate the results of model(s) 506 in terms of accuracy, consistency, hallucinations, etc.) and/or based on human interactions, which may be interactive or non-interactive.

The PQC advisor may then provide an output 510 for presentation to a user via a user interface and/or to another computer system, based on output data 508.

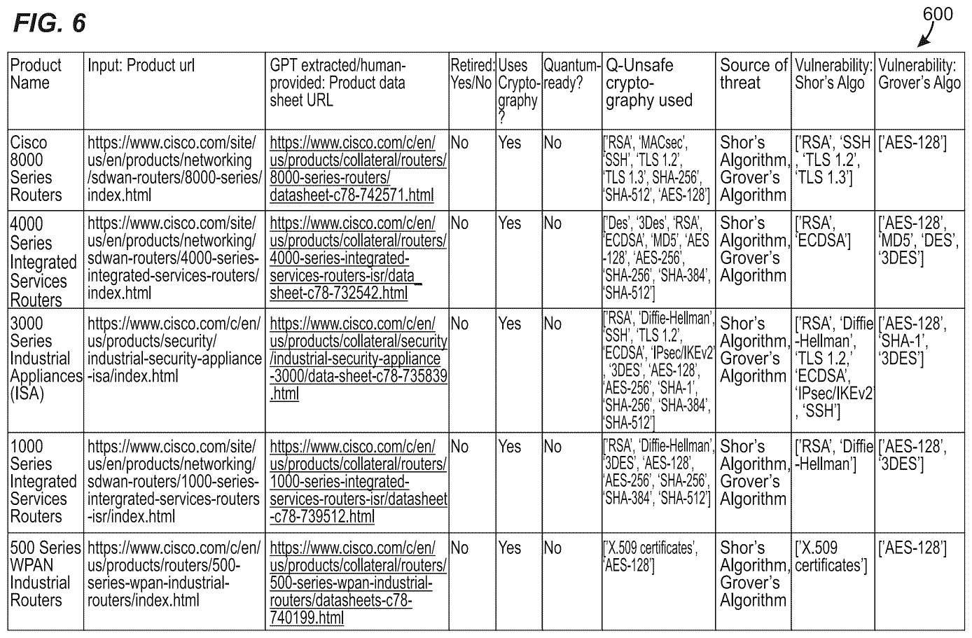

FIG. 6 illustrates an example 600 of a list of products, their associated URLs, their product data sheet URL (GPT extracted or human-provided), an indication as to whether that product is retired, an indication as to whether the product uses cryptography, an assessment as to whether the product is quantum-ready, the quantum unsafe cryptography that the product uses (if any), the source of the threat (if any), and vulnerability information.

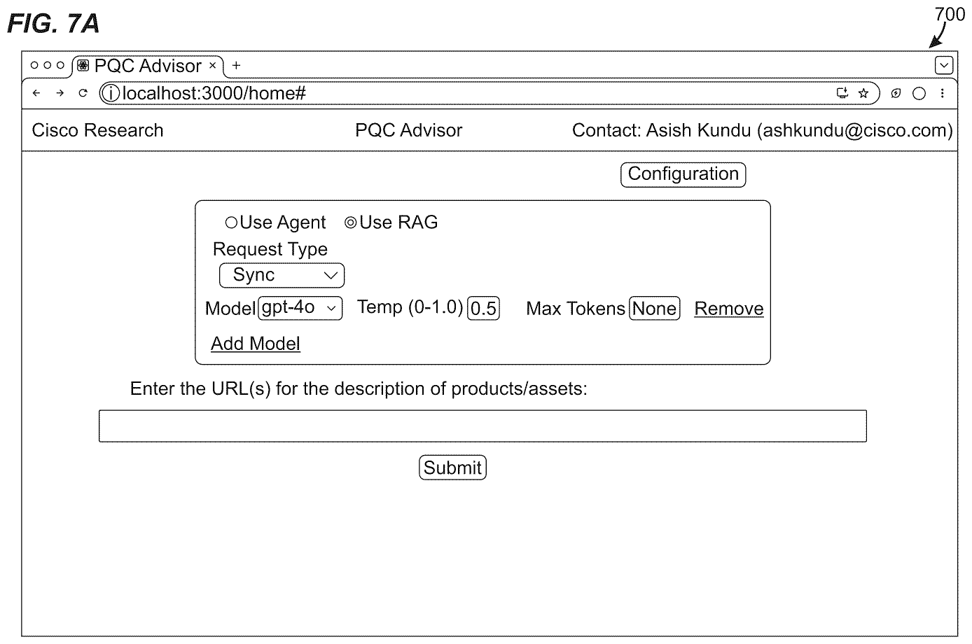

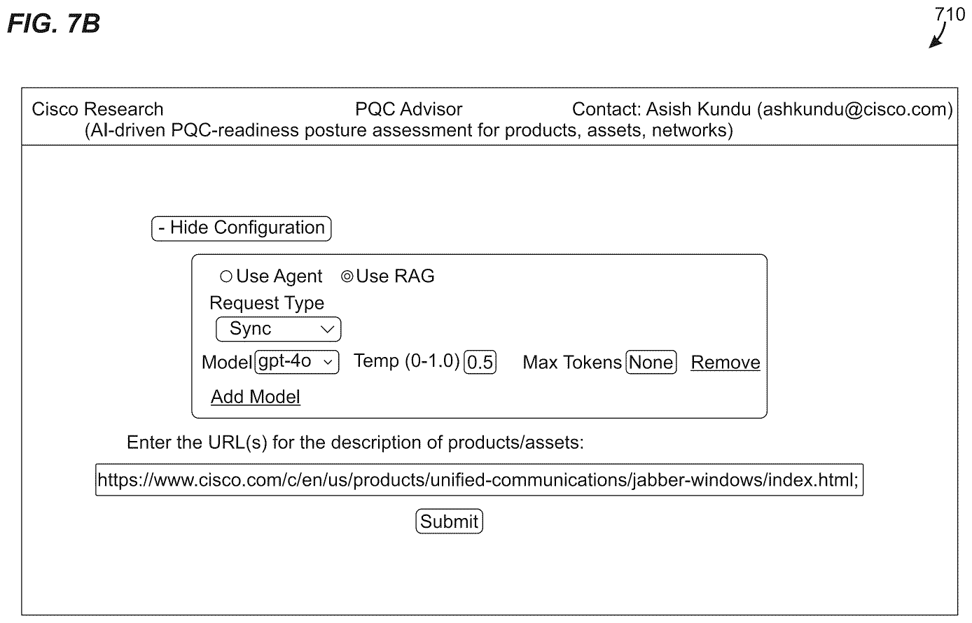

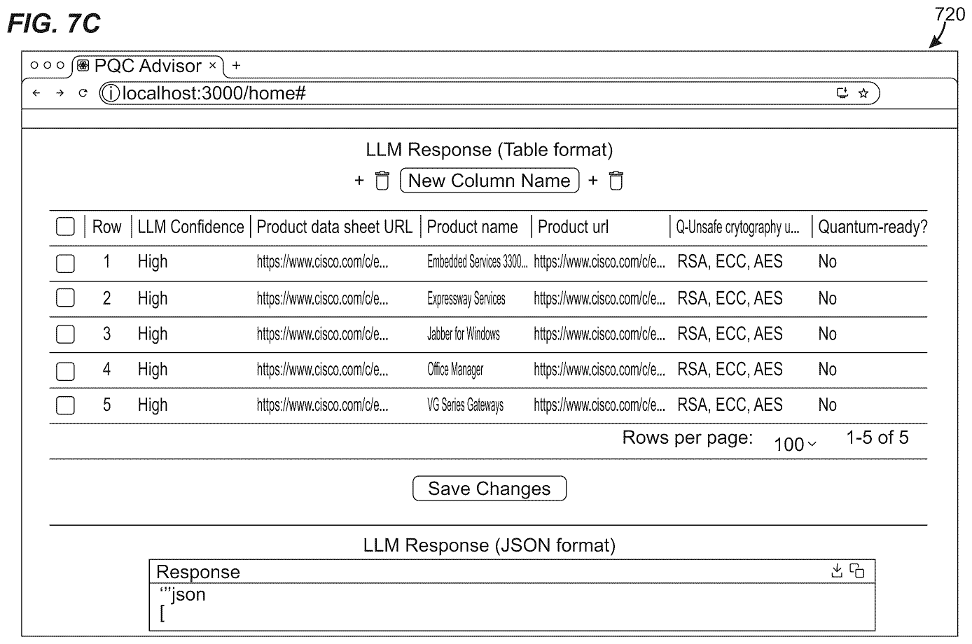

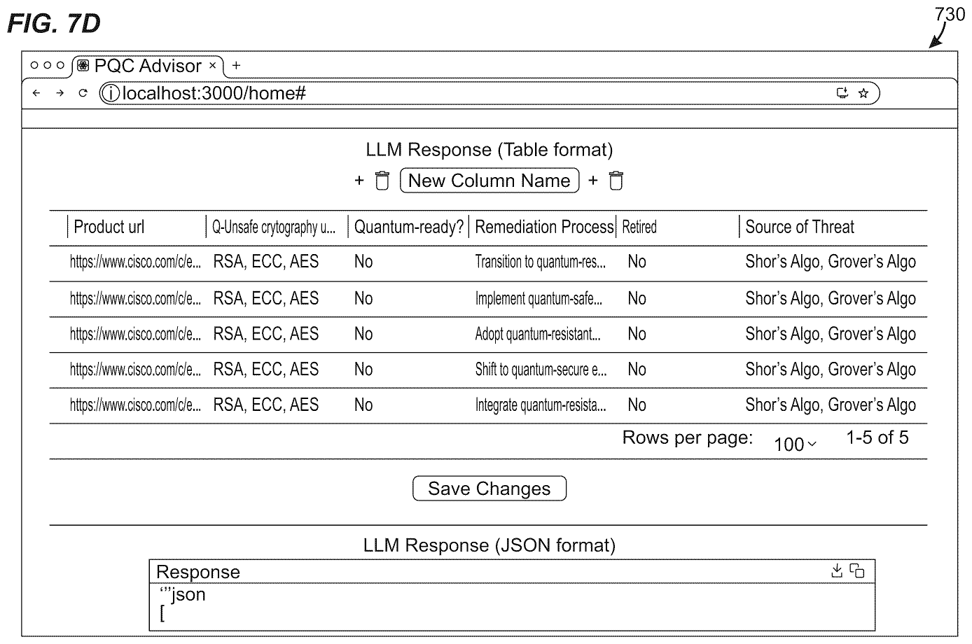

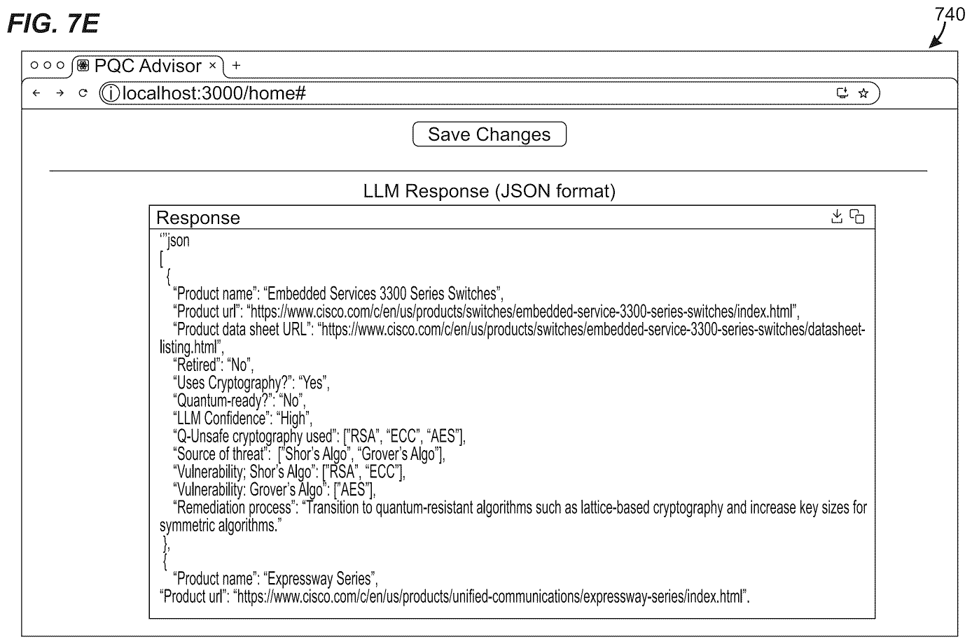

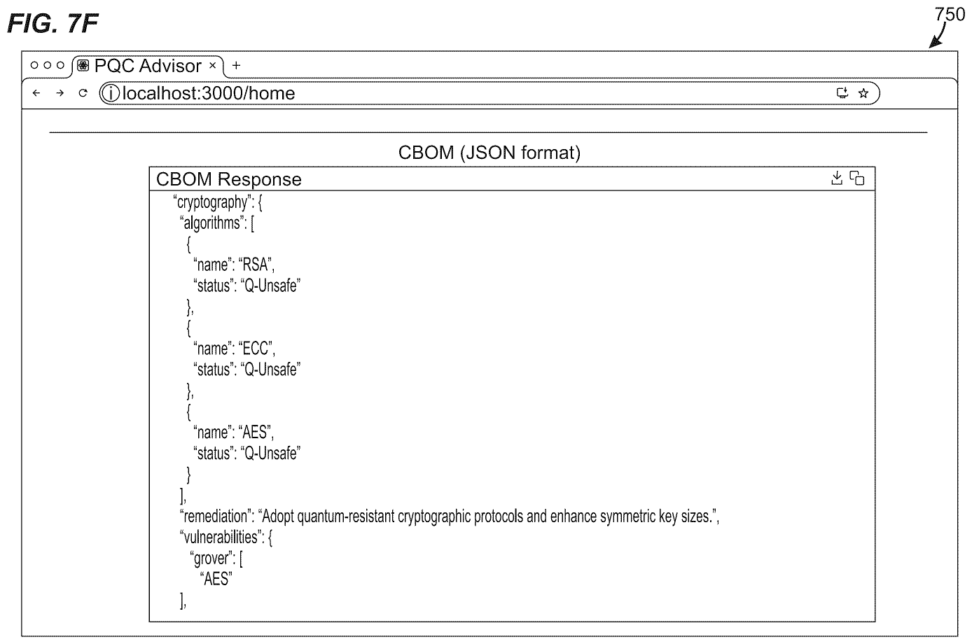

A prototype system was also developed to show the efficacy of the techniques herein. FIGS. 7A-7F illustrates screen captures 700-750 of the prototype system in use. As shown in FIG. 7A, screen capture 700 shows a user interface for a PQC advisor that allows a user to select between using an agent or RAG mechanism, a request type, the LLM or other model to use, and the URL(s) to the products/assets that the PQC advisor is to assess. For instance, screen capture 710 in FIG. 7B shows the entry of a given URL into the system.

Screen capture 720 in FIG. 7C shows the response of the PQC advisor via its user interface in table format. Such information may indicate, for example, the confidence of the LLM in assessing a given URL, the URL itself, the product whose documentation is located at that URL, which cryptographic protocols were indicated by that documentation, an indication of the PQC advisor's assessment (e.g., whether the product is quantum ready), and/or other information.

Screen capture 730 in FIG. 7D shows further table fields of the table shown in FIG. 7C as a result of the user scrolling to the right. These table field may include, for instance, an indication as to the remediation steps the user could take for any given product, an indication as to whether the product is retired, the source of the threat(s) (e.g., which cryptographic protocols used by the product are not quantum safe), etc.

Screen capture 740 in FIG. 7E shows a capture of the respond of the LLM of the PQC advisor in JSON format. As noted above, the system may also output its assessment in JSON format, allowing for use by other computing systems, applications, or the like.

Screen capture 750 in FIG. 7F shows a capture of the CBOM output of the PQC advisor in JSON format. As noted above, another potential output of the system may be a CBOM that lists the different types of cryptographic protocols in use by the components of the product under scrutiny. In some instances, the PQC advisor may also include an assessment as to the PQC readiness of each of these components.

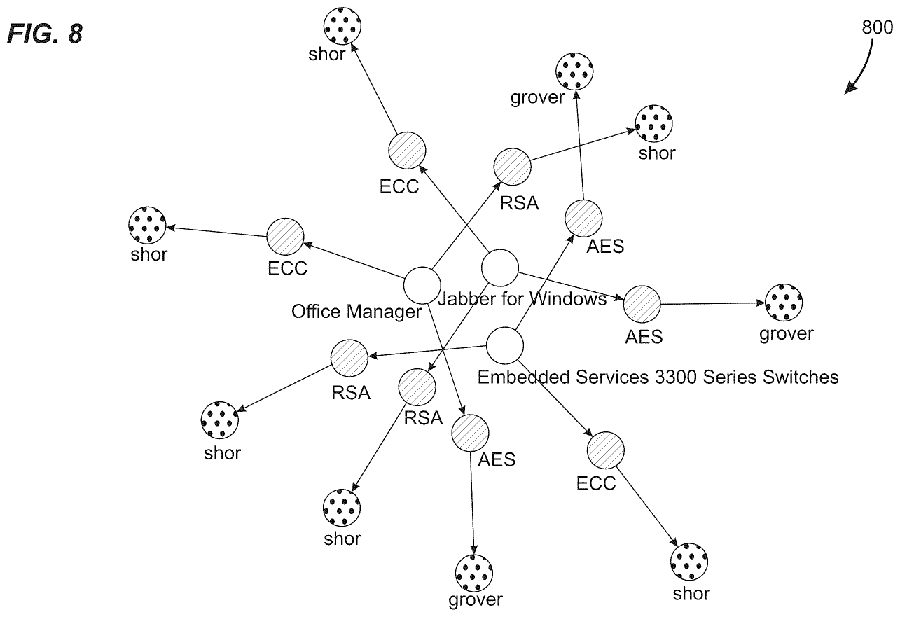

FIG. 8 illustrates an example cryptography vulnerability/dependency graph 800 that the PQC advisor may generate and/or present to a user for review. As shown, cryptography vulnerability/dependency graph 800 may take the form of a directed graph with the root nodes representing the components of the system under scrutiny (e.g., Jabber for Windows, Office Manager, etc.). Child nodes under these root nodes may represent the cryptographic protocols that they use (e.g., RSA, AES, etc.) followed by the specific algorithms in use (e.g., Shor's, Grover's, etc.).

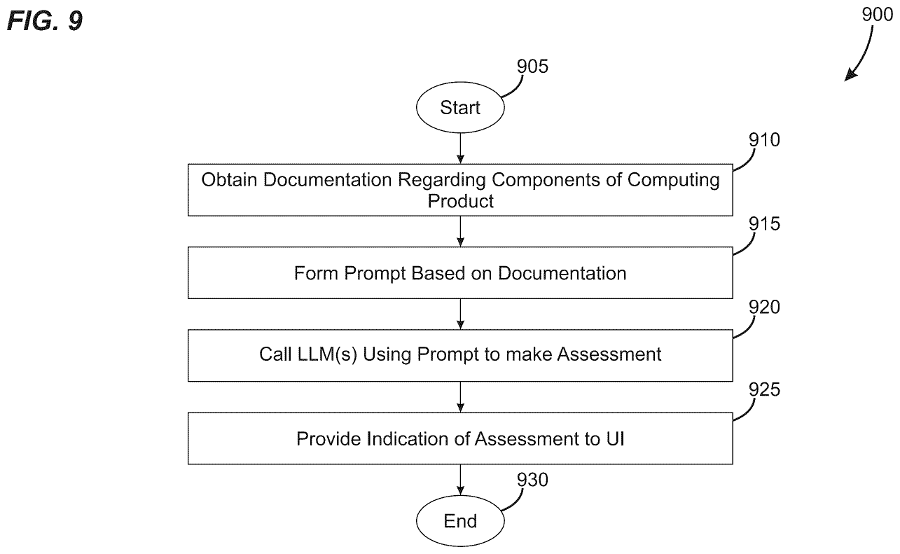

FIG. 9 illustrates an example simplified procedure for assessing the post-quantum readiness of assets and products, in accordance with one or more implementations described herein. For example, a non-generic, specifically configured device (e.g., device 200), may perform procedure 900 (e.g., a method) by executing stored instructions (e.g., security assessment process 248). The procedure 900 may start at step 905, and continues to step 910, where, as described in greater detail above, the device (e.g., a controller, server, etc.) may obtain documentation regarding components of a computing product located at one or more uniform resource locators. In some implementations, the documentation comprises multimodal descriptions for the components of the computing product. In a further implementation, the documentation comprises datasheets for the components of the computing product. In some implementations, the device may receive, via the user interface, the one or more uniform resource locators. In one implementation, the computing product is a multi-agent system that comprises a plurality of artificial intelligence-based agents.

At step 915, as detailed above, the device forms a prompt for input to one or more large language models based on the documentation. In some implementations, the prompt is based further on one or more of: a research paper, a blog, or a standard. In further implementations, the prompt is based further on one or more of: a software bill of material for one or more of the components of the computing product, a configuration of one or more of the components of the computing product, or system design information for the computing product.

At step 920, the device calls, using the prompt, the one or more large language models to make an assessment as to whether the components of the computing product are cryptographically resistant to quantum computers, as described in greater detail above. In some implementations, the assessment includes validation information indicative of a degree of trustworthiness of the assessment. In various implementations, the prompt is augmented using a retrieval augmented generation system that stores information regarding cryptographic protocols, ciphersuites, or algorithms that are not cryptographically resistant to quantum computers.

At step 925, as detailed above, the device provides an indication of the assessment to a user interface. In some implementations, the device may also generate, by using the one or more large language models and based on the documentation, a ciphersuite bill of materials for the computing product. In another implementation, the device may generate, by using the one or more large language models and based on the documentation, a cryptographic dependency graph for the components of the computing product.

Procedure 900 may then end at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for assessing the post-quantum readiness of assets and products, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
obtaining, by a device, documentation regarding components of a computing product located at one or more uniform resource locators;
forming, by the device, a prompt for input to one or more large language models based on the documentation;
calling, by the device and using the prompt, the one or more large language models to make an assessment as to whether the components of the computing product are cryptographically resistant to quantum computers; and
providing, by the device, an indication of the assessment to a user interface.

2. The method as in claim 1, further comprising:
receiving, via the user interface, the one or more uniform resource locators.

3. The method as in claim 1, further comprising:
generating, by using the one or more large language models and based on the documentation, a cryptographic dependency graph for the components of the computing product.

4. The method as in claim 1, further comprising:
generating, by using the one or more large language models and based on the documentation, a ciphersuite bill of materials for the computing product.

5. The method as in claim 1, wherein the prompt is augmented using a retrieval augmented generation system that stores information regarding cryptographic protocols, ciphersuites, or algorithms that are not cryptographically resistant to quantum computers.

6. The method as in claim 1, wherein the documentation comprises datasheets for the components of the computing product.

7. The method as in claim 1, wherein the documentation comprises multimodal descriptions for the components of the computing product.

8. The method as in claim 1, wherein the assessment includes validation information indicative of a degree of trustworthiness of the assessment.

9. The method as in claim 1, wherein the prompt is based further on one or more of: a software bill of material for one or more of the components of the computing product, a configuration of one or more of the components of the computing product, or system design information for the computing product.

10. The method as in claim 1, wherein the prompt is based further on one or more of: a research paper, a blog, or a standard.

11. An apparatus, comprising:
one or more network interfaces;
a processor coupled to the one or more network interfaces and configured to execute one or more processes; and
a memory configured to store a process that is executable by the processor, the process when executed configured to:
obtain documentation regarding components of a computing product located at one or more uniform resource locators;
form a prompt for input to one or more large language models based on the documentation;
call, using the prompt, the one or more large language models to make an assessment as to whether the components of the computing product are cryptographically resistant to quantum computers; and
provide an indication of the assessment to a user interface.

12. The apparatus as in claim 11, wherein the process when executed is further configured to:
receive, via the user interface, the one or more uniform resource locators.

13. The apparatus as in claim 11, wherein the process when executed is further configured to:
generate, by using the one or more large language models and based on the documentation, a cryptographic dependency graph for the components of the computing product.

14. The apparatus as in claim 11, wherein the process when executed is further configured to:
generate, by using the one or more large language models and based on the documentation, a ciphersuite bill of materials for the computing product.

15. The apparatus as in claim 11, wherein the prompt is augmented using a retrieval augmented generation system that stores information regarding cryptographic protocols, ciphersuites, or algorithms that are not cryptographically resistant to quantum computers.

16. The apparatus as in claim 11, wherein the documentation comprises datasheets for the components of the computing product.

17. The apparatus as in claim 11, wherein the documentation comprises multimodal descriptions for the components of the computing product.

18. The apparatus as in claim 11, wherein the computing product is a multi-agent system that comprises a plurality of artificial intelligence-based agents.

19. The apparatus as in claim 11, wherein the prompt is based further on one or more of: a software bill of material for one or more of the components of the computing product, a configuration of one or more of the components of the computing product, or system design information for the computing product.

20. A tangible, non-transitory, computer-readable medium storing program instructions that cause a device to execute a process comprising:
obtaining, by a device, documentation regarding components of a computing product located at one or more uniform resource locators;
forming, by the device, a prompt for input to one or more large language models based on the documentation;
calling, by the device and using the prompt, the one or more large language models to make an assessment as to whether the components of the computing product are cryptographically resistant to quantum computers; and
providing, by the device, an indication of the assessment to a user interface.
